(19) United States
(12) Patent Application Publication
(10) Pub. No.: US 2026/0205481 A1
(43) Pub. Date: Jul. 16, 2026

(54) SCALED COMPOSITE Z-SCORE FOR PRIORITIZING ANALYSIS OF ANOMALIES IN A NETWORK FOR INVESTIGATION

(71) Applicant: Oracle International Corporation, Redwood Shores, CA (US)

(72) Inventor: Aneesh Dahiya, Zurich (CH)

(73) Assignee: Oracle International Corporation, Redwood Shores, CA (US)

(21) Appl. No.: 19/091,714

(22) Filed: Mar. 26, 2025

Related U.S. Application Data
(60) Provisional application No. 63/745,228, filed on Jan. 14, 2025.

(51) Int. Cl. H04L 9/40

(52) U.S. Cl. CPC H04L 63/1425

(57) ABSTRACT

Example systems, methods, and computer-program products for prioritizing analysis of anomalies in a network for investigation are described. In an example, network data traffic analysis includes accessing a plurality of network traffic measurements along a plurality of dimensions. The network data traffic analysis also includes determining combined and scaled dimension-specific distances for a subset of the network traffic measurements and generating a set of aggregate composite scores for the subset of the network traffic measurements.

### CROSS REFERENCE TO RELATED APPLICATION(S)

This application claims the benefit of and priority to U.S. Provisional Patent Application No. 63/745,228, filed on Jan. 14, 2025, the entire disclosure of which is incorporated by reference herein in its entirety for all purposes.

### BACKGROUND

Network security systems may flag abnormally large messages in network traffic. Such network traffic anomalies can serve as early indicators of various security threats, such as data exfiltration attacks, injection attacks, and distributed denial of service (DDoS) attacks, among other types of network security threats.

### BRIEF SUMMARY

In some embodiments, a computer-implemented method includes a network traffic analysis system accessing a plurality of network traffic measurements along a plurality of dimensions. The method also includes determining combined and scaled dimension-specific distances for a subset of the network traffic measurements and generating a set of aggregate composite scores for the subset of the network traffic measurements.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process that prioritizes analysis of anomalies in a multi-dimensional data pipeline.

FIG. 2 illustrates a system diagram showing an example network traffic analysis system that analyzes network traffic.

FIG. 3 illustrates a diagram of an example user interface for receiving information about ranked network traffic anomalies for further investigation.

FIG. 4 depicts a simplified diagram of a distributed system for implementing certain aspects.

FIG. 5 is a simplified block diagram of one or more components of a system environment by which services provided by one or more components of an embodiment system may be offered as cloud services, in accordance with certain aspects.

FIG. 6 illustrates an example computer system that may be used to implement certain aspects.

### DETAILED DESCRIPTION

An example network traffic analysis system accesses a plurality of network traffic measurements along a plurality of dimensions. The example system determines combined and scaled dimension-specific distances for a subset of the network traffic measurements and generates a set of aggregate composite scores for the subset of the network traffic measurements.

In various embodiments, the system for prioritizing analysis of anomalies in a network is implemented using non-transitory computer-readable storage media to store instructions which, when executed by one or more processors of a computer system, cause display of the user interface and processing of received input to the system for prioritizing analysis of anomalies in a network. The system for prioritizing analysis of anomalies in a network may be implemented on a local or cloud-based computer system that includes processors and a display for showing the user interface to a user for prioritizing analysis of anomalies in a network. The computer system may communicate with client computer systems for prioritizing analysis of anomalies in a network.

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Data Exfiltration, Injection, and Distributed Denial of Service Attacks

Network security threats include any potentially negative action or event that results in an unwanted impact to a computer system or application accessible over a network. A non-exhaustive list of example network security threats includes data exfiltration attacks, injection attacks, and distributed denial of service (DDoS) attacks, among other types of network security threats. Data exfiltration typically involves an unauthorized covert transfer of data from a computer or other device. The stolen data (e.g., customer data, personally identifiable information, etc.) may be sold on a black market or held hostage in exchange for a fee (e.g., ransomware attacks). Injection attacks occur when an attacker sends malicious data to cause an application to behave in an unintended way. For example, an attacker may exploit vulnerabilities in a data processing application by submitting malicious data to trigger an unwanted logical behavior of the application. A DDoS attack is a cyber assault that typically involves flooding a network or network server with traffic to disrupt or overload the system.

### Fixed Dimension-Specific Network Security Policies

Abnormal network traffic can serve as an early indicator of network security threats such as data exfiltration attacks, injection attacks, DDoS attacks, etc. A non-exhaustive list of example abnormal network traffic events or items that can serve as early indicators of a potential network security threat includes abnormal message sizes, request sizes, response sizes, payload sizes, packet sizes, frequencies or volumes of network traffic items of a certain type, frequencies or volumes of network traffic over a window of time, an amount of time over which network traffic items are transmitted, an amount of time between network traffic items, or any combination thereof.

To enhance network security, a computer system may be configured according to a network security policy to flag potential network security threats by monitoring network traffic. For example, anomaly detection systems can be used to quickly detect network traffic anomalies by analyzing large volumes of network data that would otherwise require a long time to manually analyze. In some configurations, an anomaly detection system applies a fixed network security policy to identify and flag potential anomalies. For example, the system may be configured to flag abnormally large messages based on a statistical distribution of message sizes.

The flagged anomalies can then be analyzed or investigated more thoroughly to confirm whether any of the flagged anomalies is associated with a potential network security threat and/or to trigger other threat remediation processes. For example, a network security expert may investigate network traffic associated with each flagged anomaly to determine whether that anomaly is associated with an actual network security threat or if the anomaly is only a statistical outlier (e.g., false positive).

In some scenarios, the process for investigating flagged anomalies may be time or resource intensive. Excessive time spent on investigating outliers or false positives may delay detection and/or remediation of actual network security threats indicated by other flagged anomalies. Accordingly, in some examples, an anomaly detection system is configured to filter and/or prioritize detected anomalies flagged for further review or investigation. In some configurations, an example system may filter and/or prioritize detected anomalies using a statistical score (e.g., Z-score, T-score, etc.).

The Z-score (e.g., standard score) is a way of describing a data point in terms of its relationship to the mean and standard deviation of a plurality of data points. For example, a Z-score may map data onto a standard distribution having a mean of 0 and a standard deviation of 1. By computing a Z-score, artifacts such as location and/or data scale may be removed thereby allowing different datasets to be compared efficiently. For example, once a dataset is centered and rescaled, the Z-score enables efficient detection of outliers (e.g., datapoints that are away from the mean may be considered as outliers). In some examples, the Z-score threshold used to flag anomalies or outliers may be a value of 3 or −3. Other example thresholds are possible as well. In some examples, a system is configured to assume data is distributed normally (e.g., bell shaped curve). In these examples, the mean value plus or minus three standard deviations may capture approximately 99.7% of observations. Thus, in these examples, values falling outside this range may be considered as anomalies.

In some embodiments, an example system may compute a modified Z-score to measure a central tendency or dispersion of the underlying data. In some scenarios, the mean or standard deviation may be affected by outliers. For instance, skewing associated with outliers may affect relatively small datasets. Thus, a modified Z-score may improve detection of outliers. For instance, a modified Z-score may improve outlier detection in data that is not normally distributed and/or where the number of observations is limited. In one example, a system may compute a modified Z-score by using the median and/or median absolute deviation (MAD) to provide a more robust measure of central tendency and/or dispersion of data that is not normally distributed. Thus, in various implementations, other modifications to the Z-score computation are possible as well without departing from the scope of the present disclosure.

By way of example, to flag and prioritize abnormally large messages in a day, an example system may compute a Z-score for message size of each message in the day by estimating the average message size and standard deviation of the messages monitored during the day. If message sizes follow a normal distribution, the Z-score indicates the probability of a message size being an outlier. For example, approximately 0.13% of message size values will have an absolute Z-score value greater than 3. Higher Z-scores, such as 3.5 or 4, have even lower probabilities, and lower Z-scores, such as 2.5 or 2, have higher probabilities. Even in cases when the distribution is not normal, Z-score may still be a good indicator because abnormally large messages will still have a higher Z-score than normal messages. Thus, Z-score (and/or other statistical scoring metrics) can be used as a metric for selecting, filtering, and/or prioritizing analysis of anomalies for further investigation.

### Dynamic Anomaly Detection and Prioritization

In some scenarios, static anomaly detection mechanisms may be less effective at identifying and flagging the most relevant anomalies associated with potential network security threats. For example, in an anomaly detection system that monitors message sizes, a message size that is abnormally large in one network may be normal in another network. Furthermore, a message size can be influenced by various other factors, such as time of the day, day of the week, source, destination, application programming interface (API) path, etc. Thus, message sizes of messages associated with a particular feature may have a different statistical distribution (e.g., with a different mean and/or standard deviation) than message sizes of messages associated with a different feature. Ignoring the influence of different features or dimensions in the data being monitored for anomalies could thus result in less accurate detections and/or prioritization of anomalies (e.g., false positives, false negatives, etc.). Examples described herein include methods and systems for dynamic anomaly detection and prioritization that accounts for multi-dimensional data pipelines.

In one example, a system is configured to calculate a Z-score along each of one or more multiple dimensions (e.g., Z-score for messages from source 1 and a Z-score for messages from source 2, etc.) in the data pipeline. The system may then use an aggregate Z-score to flag an outlier. For example, the system may be configured to perform averaging or weighted-averaging of the Z-scores along different dimensions.

However, in some configurations, simple averaging of Z-scores to get a composite Z-score may result in inaccuracies if the distribution along all the dimensions is not normal if the dimensions are skewed, or otherwise similar. For instance, if a first dimension has a non-normal distribution, Z-scores in the first dimension may be generally higher than Z-scores in a second dimension having a normal distribution. Thus, in this instance, averaging Z-scores of the first and second dimensions may result in suppression of valid Z-scores of message sizes associated with the second dimension. More generally, averages may be susceptible to large outliers (e.g., a large outlier may influence the average value).

Furthermore, aggregating Z-scores across dimensions using a median value of Z-scores may ignore relevant anomalies associated with dimensions that have Z-scores different from the median value. For example, a median Z-score value may result in an over-representation of anomalies associated with a particular dimension (having Z-scores closer to the median) than anomalies associated with another dimension.

Accordingly, the present disclosure includes example systems and methods for multi-dimensional dynamic anomaly detection and prioritization that account for variations between distributions associated with different dimensions to more accurately detect, flag, and prioritize analysis of anomalies in a multi-dimensional data pipeline. For example, an anomaly detection system herein may account for anomalies in each dimension separately (by considering the distribution of measurements in each dimension when calculating its Z-score) and then prioritize the aggregated anomalies without overrepresenting the anomalies associated with any particular dimension.

By way of example, the system may select the top N candidate messages associated with a first dimension (e.g., having a Z-score in the first dimension that is greater than a threshold) and the top M candidate messages associated with a second dimension (e.g., having a Z-score in the second dimension that is greater than the threshold. The two lists are then merged (e.g., messages that are in both lists are listed once in the merged list). A composite Z-score is then calculated for each message in the merged list by scaling and aggregating the dimension-specific Z-score of each message of the merged list. For example, anomalies that have a relatively high Z-score in both dimensions may have a higher composite Z-score in the merged list than anomalies that have a relatively high Z-score in only one dimension.

### Managing a Multi-Dimensional Data Pipeline

In some aspects, an example system monitors a multi-dimensional data pipeline, such as network traffic associated with one or more servers of a networked system or cloud infrastructure. The metric being monitored in the network traffic is first selected, such as message size, request size, response size, payload size, packet size, frequency or volume of network traffic items, an amount of time over which network traffic items are transmitted, an amount of time between network traffic items, etc. Then, one or more features and/or categories that may influence the metric are selected (e.g., dimensions). In general, a categorical dimension can take on one of a limited, and/or fixed, number of possible values (e.g., time of the day, source, destination etc).

For the sake of example, consider a scenario where the metric being monitored is message size of HTTP messages. For example, the categorical dimensions of interest may include message source (e.g., service 1, service 2, etc.) and user agent (e.g., safari, chrome, etc.) from which the message was transmitted. In this example, an example system may detect N messages on the network in a day. Thus, in this example, the system may measure mean and standard deviation statistics for traffic in each dimension during the day as illustrated below in Table 1.

TABLE 1
Table showing average message size and standard
deviation along each dimension:

| Source | μ_{source} | σ_{source} |
|---|---|---|
| Service 1 | 30K | 5K |
| Service 2 | 500 | 100 |
| User Agent | μ_{user-agent} | σ_{user-agent} |
| Safari | 50K | 20K |
| Chrome | 30K | 10K |

The example system may store or access information about all the messages N detected during the day (e.g., message ID, user agent, source, message size, etc.).

### Anomaly Analysis In Multiple Dimensions

In some aspects, example systems and methods herein perform anomaly analysis in multiple dimensions to identify, filter, and/or prioritize analysis of anomalies in each dimension. For example, a Z-score (or other scoring metric) may be calculated for each network traffic item being monitored in the multi-dimensional data pipeline. Continuing with the example of Table 1, let dⱼ be defined as a j^{th} categorical dimension, where the data pipeline is defined to have J dimensions in total. The example system may compute a Z-score for each sample message of the N messages associated with μsource, σsource, μuser-agent, and σuser-agent statistics computed in Table 1. The Z-score for i^{th} sample sᵢ along dⱼ can be calculated using the mean message size μⱼ and standard deviation σⱼ along dⱼ as indicated in Equation (1) below.

$${Z}_{ij} = \frac{{s}_{i} - {μ}_{j}}{{σ}_{j}} \qquad ( 1 )$$

Table 2 presents example results of the Z-score computations for the example N messages.

TABLE 2
Table showing few samples from Network traffic with
feature User Agent and Source alongside message size:

| No. | User Agent | Source | Message size | Z_{user-agent} | Z_{Source} |
|---|---|---|---|---|---|
| 1 | Chrome | Service 1 | 50K | (50K − 30K)/10K = 2.0 | (50K − 30K)/5K = 4.0 |
| 2 | Chrome | Service 2 | 1K | (1K − 30K)/10K = −2.9 | (1K − 500)/100 = 5.0 |
| 3 | Safari | Service 1 | 30K | (30K − 50K)/20K = −1.0 | (30K −30K)/5K = 0.0 |
| 4 | Safari | Service 2 | 500 | (500 − 50K)/20K = −2.25 | (500 − 500)/100 = 0.0 |
| 5 | Chrome | Service 1 | 45K | (45K − 30K)/10K = 1.5 | (45K − 30K)/5K = 3.0 |
| 6 | Safari | Service 2 | 600 | (600 − 50K)/20K = −2.2 | (600 − 500)/100 = 1.0 |
| . . . | . . . | . . . | . . . | . . . | . . . |
| N | Chrome | Service 2 | 450 | (450 − 30K)/10K = −2.95 | (450 − 500)/100 = −0.5 |

The example system may then use the Z-scores to select the top top mⱼ samples along each dimension dⱼ with the highest Z-score. mⱼ may be computed as show in in Equations (2) and (3) below.

$${m}_{j} = N \times P ( {z}_{j} > 3 ) \qquad ( 2 )$$

$${m}_{j} = N \times 0.0013 \qquad ( 3 )$$

For example, P (zⱼ>3) is the probability of a sample having a Z-score zⱼ greater than 3 in an normal distribution, namely 0.13%. However, other threshold Z-score values are possible as well depending on the application. If the distributions along a dimension dⱼ is normal then the top mⱼ samples along this dimension may be on average equal to the number of samples with Zᵢⱼ>3. For the scenario where distribution along one or more dimension is not normal this may result in at most 0.0013×N samples mⱼ.

### Scaling and Aggregating Anomaly Analysis Results

In some aspects, an example system is configured to aggregate and scale the anomaly samples across the various dimensions analyzed to generate an aggregated list of anomalies. By way of example, From the top mⱼ samples per dimension, the system may select all kⱼ samples which have Z-score greater than 3 (or other score threshold). Then, for all of the kⱼ samples, the example system may scale Zᵢⱼ for each sample to a value between 0 and 1 along each dimension dⱼ.

Continuing with the Example of Tables 1 and 2 for instance, after the calculation of Z scores, the example system may select the k samples that are in top m and also have a Z-score greater than 3. Since for the User-Agent no sample has Z-score higher than 3 for example, the system may select samples based on the source. Table 3 shows an example calculation of scaled Z-scores. In this example, Z-scores are scaled based on min and max of the selected k samples to map to the range 0 and 1.

TABLE 3
Table showing scaled Z scores for the selected k samples:

| No. | User Agent | Source | Message size | Z_{user-agent} | Z_{Source} | \tilde{Z}_{user-agent} | \tilde{Z}_{Source} |
|---|---|---|---|---|---|---|---|
| 1 | Chrome | Service 1 | 50K | 2.0 | 4.0 | $\frac{( 2 + 2.9 )}{( 2 + 2.9 )} = 1.$ | $\frac{4 - 3}{5 - 3} = 0.5$ |
| 2 | Chrome | Service 2 | 1K | −2.9 | 5.0 | $\frac{( - 2.9 + 2.9 )}{( 2 + 2.9 )} = 0$ | $\frac{5 - 3}{5 - 3} = 1$ |
| 5 | Chrome | Service 1 | 45K | 1.5 | 3.0 | $\frac{( 1.5 + 2.9 )}{( 2 + 2.9 )} = 0.9$ | $\frac{3 - 3}{5 - 3} = 0$ |

In some examples, the system may then aggregate the scaled Z-scores (e.g., values between 0 and 1) by computing a weighted average Z-score using the scaled Z-scores, according to equation (4) below.

$${Z}^{∼} i = \frac{\sum {w}_{j} \times {Z}^{∼} ij}{J \sum {w}_{j}} \qquad ( 4 )$$

In some examples, the weight wⱼ may be determined based on the domain knowledge from the Security experts on the Network traffic. Effectively this makes a specific dimension of more interest based on expert opinion. The example system may use the composite score Z\tilde{ }i to prioritize the investigation of messages. For example, messages having a higher composite Z\tilde{ }i score may be assigned a higher priority for further investigation.

Continuing with the example of Tables 1-3, the composite Z-scores for messages 1, 2, and 5 are summarized in Table 4 below (where the weights wⱼ are assumed to be 1 for the sake of example).

TABLE 4
Table with composite score for outliers

| No. | Message size | Z_{user-agent} | Z_{Source} | Z_{composite} |
|---|---|---|---|---|
| 1 | 50K | 1.0 | 0.5 | 0.75 |
| 2 | 1K | 0 | 1 | 0.5 |
| 5 | 45K | 0.9 | 0 | 0.45 |

In this example, the anomaly associated with message 1 may be assigned the highest investigation priority based on having the highest composite Z-score, and so on.

### Using A Composite Scoring Mechanism To Select And Prioritize Analysis Of Anomalies In A Multi-Dimensional Data Pipeline

In some aspects, an example system herein provides a paradigm to factor in multiple dimensions to prioritize investigation of large messages in network traffic. By way of example, the composite Z-score described in the sections above uses an aggregate score that is based on a scaled Z-score for each dimension. In particular, samples are first filtered based on rank of dimensional Z-scores (e.g., top m) and then k samples are filtered based on a Z-score threshold. M and k may be calculated based on a normal distribution ensuring theoretical support. Furthermore, the linear (e.g., min-max) scaling of dimensional Z-scores of filtered samples to a range (e.g., [0, 1]) may ensure that abnormally high Z-scores of an anomaly in one dimension does not suppress the Z-scores of other dimensions. Furthermore, the weighted aggregation of scaled Z-scores enables users to prioritize anomaly investigation in a customizable manner.

By way of example, if a network traffic item has a maximum Z-score value of 50 in one dimension, the scaled Z-score value for that item may be set to 1 and all other Z-score values in the dimension may be scaled from 0 to 1. Furthermore, if the maximum Z-score in another dimension is 5, its scaled value will also be 1. In this way, anomalies particular to each direction will have a fair chance of being flagged (i.e., the unusually high Z-score value of 50 in one dimension will not suppress high Z-score values in the other dimension).

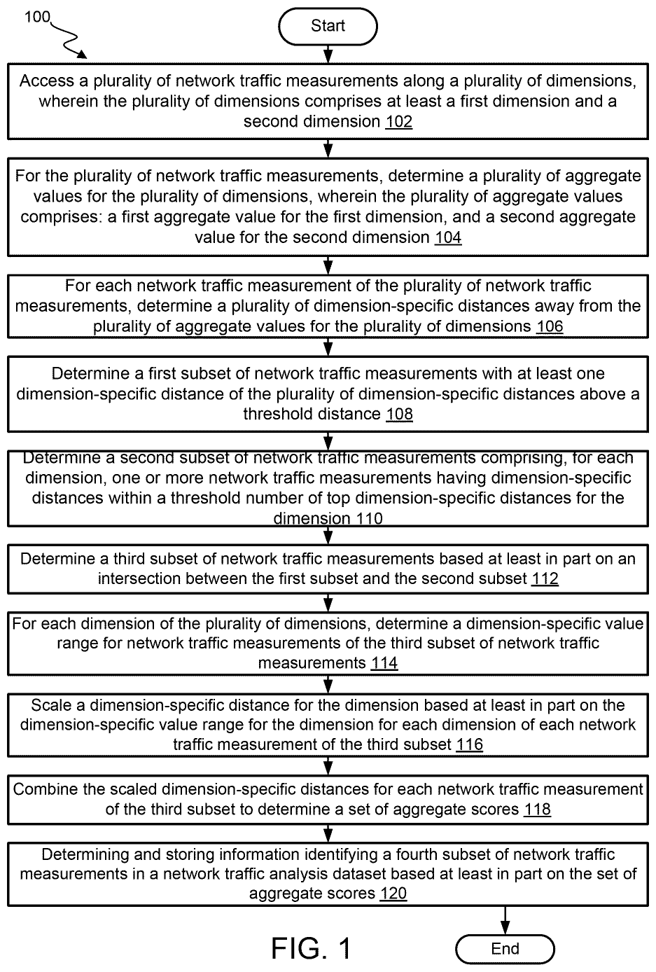

FIG. 1 illustrates a flow chart of an example process 100 that prioritizes analysis of anomalies in a multi-dimensional data pipeline. The process 100 begins at block 102 where a network traffic analysis system accesses a plurality of network traffic measurements along a plurality of dimensions. The plurality of dimensions comprises at least a first dimension and a second dimension. By way of example, the system may access the network traffic measurements (e.g., message sizes, etc.) from one or more gateways or in a network traffic dataset.

The plurality of measurements may include sizes of messages or other network traffic items, request sizes, response sizes, payload sizes, packet sizes, frequencies or volumes of network traffic items of a certain type, frequencies or volumes of network traffic over a window of time, an amount of time over which network traffic items are transmitted, an amount of time between network traffic items, or any combination thereof. The plurality of dimensions may include size categories of network traffic items, frequency categories of network traffic items of a particular type, a source node, address, application, gateway, or service of network traffic data, a destination node, address, application, gateway, or service of network traffic data, a user associated with network traffic items, a tool or browser used for processing network traffic items, a categorical time or window of time of network traffic items, a categorical time or window of time between network traffic items, or another particular characteristic of network traffic items.

At block 104, the process 100 involves the network traffic analysis system determining a plurality of aggregate values for the plurality of dimensions for the plurality of network traffic measurements. The plurality of aggregate values comprise a first aggregate value for the first dimension and a second aggregate value for the second dimension. For example, the first aggregate value may be a mean of values for the first dimension (e.g., μsource) and the second aggregate value is a mean of values for the second dimension (e.g., μuser-agent).

At block 106, the process 100 involves the network traffic analysis system determining a plurality of dimension-specific distances (e.g., Z-scores) away from the plurality of aggregate values for the plurality of dimensions for each network traffic measurement of the plurality of network traffic measurements. The plurality of dimension-specific distances comprise a first dimension-specific distance away from the first aggregate value for the first dimension and a second dimension-specific distance away from the second aggregate value for the second dimension. For example, the first dimension-specific distance is measured in terms of standard deviations of the first dimension away from the first aggregate value (e.g., Zsource) and the second dimension-specific distance is measured in terms of standard deviations of the second dimension away from the second aggregate value (e.g., Zuser-agent).

At block 108, the process 100 involves the network traffic analysis system determining a first subset of network traffic measurements with at least one dimension-specific distance of the plurality of dimension-specific distances above a threshold distance. For example, the threshold distance may be a Z-score value of 3, and the first subset (e.g., mⱼ) may the top samples corresponding to the probability associated with a Z-score value of 3 (e.g., the top 0.13% of the samples in each dimension).

At block 110, the process 100 involves the network traffic analysis system determining a second subset of network traffic measurements comprising, for each dimension, one or more network traffic measurements having dimension-specific distances within a threshold number of top dimension-specific distances for the dimension.

At block 112, the process 100 involves the network traffic analysis system determining a third subset of network traffic measurements based at least in part on an intersection between the first subset and the second subset. For example, from the top mⱼ samples, all the kⱼ samples having a greater Z-score than 3 are selected.

At block 114, the process 100 involves the network traffic analysis system determining a dimension-specific value range for network traffic measurements of the third subset of network traffic measurements for each dimension of the plurality of dimensions.

At block 116, the process 100 involves the network traffic analysis system scaling a dimension-specific distance for the dimension based at least in part on the dimension-specific value range for the dimension for each dimension of each network traffic measurement of the third subset. In the example of Table 3 for instance, the Z_{user-agent} range of values from −2.9 to 2 are scaled to values between 0 and 1. Similarly, the Z_{source} values between 3 and 5 are scaled to values between 0 and 1. Thus, in some examples, the scaling comprises linear scaling along the dimension-specific value range for the dimension (e.g., scale dimension-specific value range to values between 0 and 1 linearly).

At block 118, the process 100 involves the network traffic analysis system combining the scaled dimension-specific distances for each network traffic measurement of the third subset to determine a set of aggregate scores. For example, the scaled Z-scores of each dimensions are combined (e.g., using a weighted averaging algorithm) to generate composite z-scores for each item (e.g., message) in the merged list of anomalies.

In some examples, the process 100 also involves the network traffic analysis system storing a plurality of dimension-specific weights for the plurality of dimensions, where the scaling the dimension is further based at least in part on the dimension-specific weight for the dimension. For example, a user may select a higher weight for Z-scores associated with a first dimension (e.g., sources) than a weight to be applied for Z-scores associated with a second dimension (e.g., user agents).

In some examples, the process 100 also involves the network traffic analysis system determining a dimension-specific weight of the first dimension based at least in part on feedback from a network traffic analysis pipeline, where the feedback indicates a frequency by which network traffic measurements having higher values for the first dimension than other network traffic measurements are labeled as anomalous. By way of example, the weight used for Z-scores of the first dimension or the second dimension may be dynamically updated if the one of the dimensions is deemed to be more relevant to actual security threats.

At 120, the process 100 involves the network traffic analysis system determining and storing information identifying a fourth subset of network traffic measurements in a network traffic analysis dataset based at least in part on the set of aggregate scores. For example, the system may store a ranked/ordered list of potential anomalies for further investigation (e.g., Table 4) in the dataset.

In some examples, the process 100 also involves the network traffic analysis system triggering an electronic notification to a user associated with the network traffic analysis dataset. For example, the system may generate review tasks and send them as notifications to an anomaly review team based on the priorities indicated by the composite Z-scores.

In some examples, the process 100 also involves the network traffic analysis system causing display, in a client device of a user analyzing the plurality of network traffic measurements, of network traffic measurements of the network traffic analysis dataset in response to determining and storing the information identifying the fourth subset of network traffic measurements. For example, a user interface of the user may be updated automatically to show an ordered list of the flagged anomalies corresponding to the fourth subset. Thus, in some examples, the causing display of the network traffic measurements of the network traffic analysis dataset comprises causing display of the network traffic measurements in an order based on the set of aggregate scores.

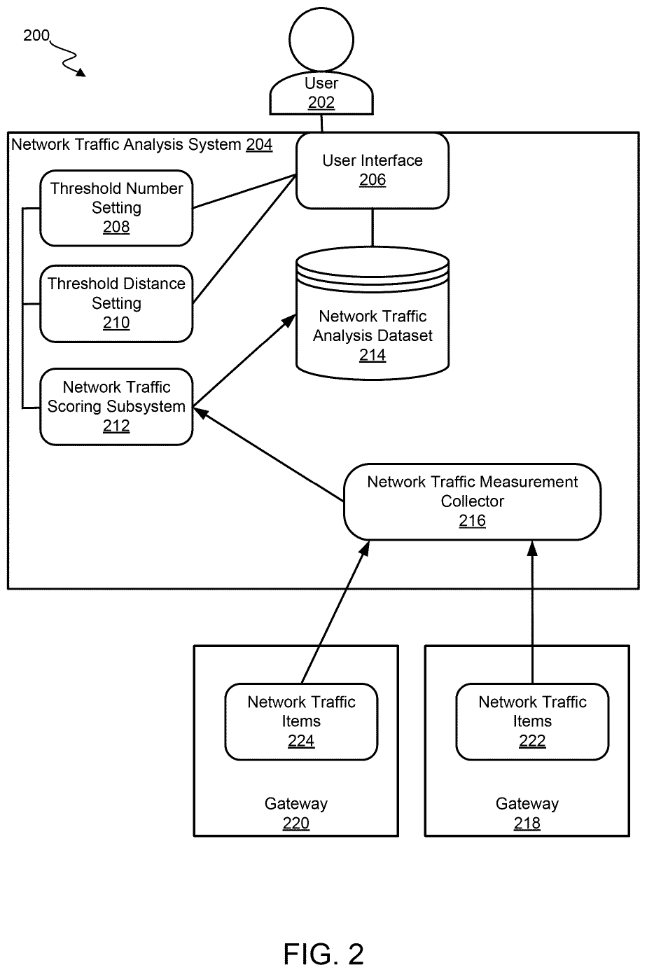

FIG. 2 illustrates a system diagram 200 showing an example network traffic analysis system 204 that analyzes network traffic. The system 200 may be configured to perform the functions of the process 100. The network traffic analysis system 204 includes a user interface 206, threshold number setting 208, threshold distance setting 210, network traffic scoring subsystem 212, network traffic analysis dataset 214, and network traffic measurement collector 216. For example, the user 202 can use the user interface 206 to submit new values for the threshold number setting 208 (e.g., m) and/or the threshold distance (e.g., kⱼ). As another example, the user interface 206 may display a ranked list of anomalies for further investigation (e.g., obtained from the network traffic analysis dataset 214. The network traffic scoring subsystem 212 may analyze network traffic items (e.g., incoming data packets) to determine a subset of the network traffic items and sort them for entry into the network traffic analysis dataset 214. Thus, for example, the network traffic analysis dataset 214 may store flagged anomalies indicated by the network traffic scoring subsystem 212. To that end, the network traffic measurement collector 216 is configured to receive and/or monitor network traffic items 222, 224 from gateways 218, 220, and to forward information about the network traffic items 222, 224 (e.g., sizes, frequencies, sources, destinations, etc.) to the network traffic scoring subsystem 212.

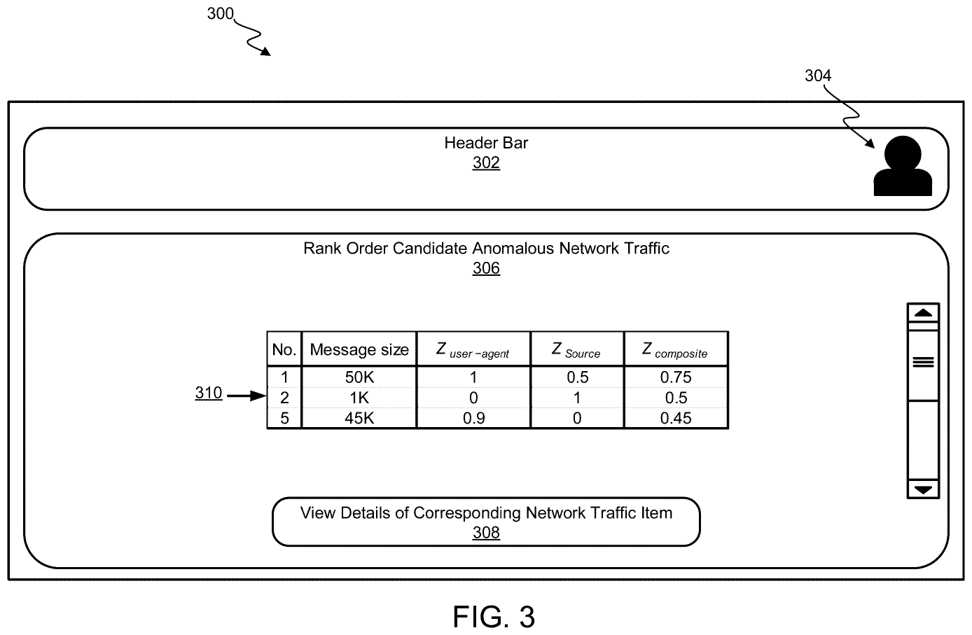

FIG. 3 illustrates a diagram of an example user interface 300 for receiving information about ranked network traffic anomalies for further investigation. The user interface 300 includes a header bar 302 showing user credentials (e.g., user image 304) of a user authorized to access the system 200. The user interface 300 also includes an interface element 306 showing rank order candidate anomalous network traffic (e.g., list of anomalies sorted and/or selected using a composite scoring algorithm that considers anomalies across multiple dimensions. The user interface 300 may also include control element 308 (e.g., ‘View Details of Corresponding Network Traffic Item’, which causes the user interface to display additional details about a network traffic item that is selectable on the user interface 300 using the selector 310.

### Automated And Semi-Automated Remediation Of Dynamically Detected Multi-Dimension Anomalies

In some aspects, an example system is configured to automatically perform remediation actions based on the dynamically detected multi-dimension anomalies. Continuing with the example of Table 4, an example system may submit an ordered list of flagged anomalies as investigation tasks assignable to network security experts. The System may also set a priority flag (e.g., high priority, medium priority, etc.) to each task based on the composite Z-score.

In some aspects, an example system includes one or more network anomaly detection agents configured to provide network anomaly detection metrics to a cloud infrastructure management system. In an example, the cloud infrastructure management system may be configured to use the network anomaly detection metrics (e.g., outliers, etc.) to manage network resources, storage resources, and/or software resources in a cloud infrastructure. For instance, the cloud infrastructure management system may pre-emptively halt or pause a pipeline based on an expected failure, thereby saving software resources, storage resources, etc. In an example, a system herein may provide a service to the cloud infrastructure management system that may be subscribed to for alerts (e.g., when an anomaly is detected an alert is triggered and submitted to the cloud infrastructure systems. For instance, the cloud infrastructure management system may interact wit the example system via an application programming interface (API). In an example, a system herein may provide feedback on network traffic for incorporation with other network traffic metrics and/or other cloud infrastructure metrics for use in managing the cloud infrastructure.

### Computer System Architecture

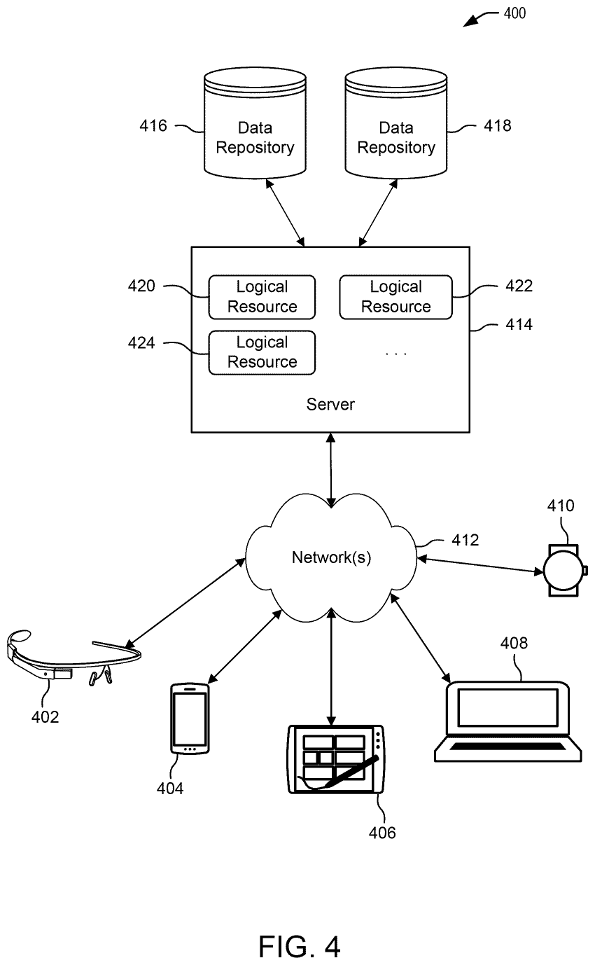

FIG. 4 depicts a simplified diagram of a distributed system 400 for implementing an embodiment. In the illustrated embodiment, distributed system 400 includes one or more client computing devices 402, 404, 406, 408, and/or 410 coupled to a server 414 via one or more communication networks 412. Clients computing devices 402, 404, 406, 408, and/or 410 may be configured to execute one or more applications.

In various aspects, server 414 may be adapted to run one or more services or software applications that enable techniques for prioritizing analysis of anomalies in a network.

In certain aspects, server 414 may also provide other services or software applications that can include non-virtual and virtual environments. In some aspects, these services may be offered as web-based or cloud services, such as under a Software as a Service (SaaS) model to the users of client computing devices 402, 404, 406, 408, and/or 410. Users operating client computing devices 402, 404, 406, 408, and/or 410 may in turn utilize one or more client applications to interact with server 414 to utilize the services provided by these components.

In the configuration depicted in FIG. 4, server 414 may include one or more components 420, 422 and 424 that implement the functions performed by server 414. These components may include software components that may be executed by one or more processors, hardware components, or combinations thereof. It should be appreciated that various different system configurations are possible, which may be different from distributed system 400. The embodiment shown in FIG. 4 is thus one example of a distributed system for implementing an embodiment system and is not intended to be limiting.

Users may use client computing devices 402, 404, 406, 408, and/or 410 for techniques for prioritizing analysis of anomalies in a network in accordance with the teachings of this disclosure. A client device may provide an interface that enables a user of the client device to interact with the client device. The client device may also output information to the user via this interface. Although FIG. 4 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 412 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 412 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 414 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 414 can include one or more virtual machines running virtual operating systems, or other computing architectures involving virtualization such as one or more flexible pools of logical storage devices that can be virtualized to maintain virtual storage devices for the server. In various aspects, server 414 may be adapted to run one or more services or software applications that provide the functionality described in the foregoing disclosure.

The computing systems in server 414 may run one or more operating systems including any of those discussed above, as well as any commercially available server operating system. Server 414 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 414 may include one or more applications to analyze and consolidate data feeds and/or event updates received from users of client computing devices 402, 404, 406, 408, and/or 410. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 414 may also include one or more applications to display the data feeds and/or real-time events via one or more display devices of client computing devices 402, 404, 406, 408, and/or 410.

Distributed system 400 may also include one or more data repositories 416, 418. These data repositories may be used to store data and other information in certain aspects. For example, one or more of the data repositories 416, 418 may be used to store information for techniques for prioritizing analysis of anomalies in a network. Data repositories 416, 418 may reside in a variety of locations. For example, a data repository used by server 414 may be local to server 414 or may be remote from server 414 and in communication with server 414 via a network-based or dedicated connection. Data repositories 416, 418 may be of different types. In certain aspects, a data repository used by server 414 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 416, 418 may also be used by applications to store application data. The data repositories used by applications may be of different types such as, for example, a key-value store repository, an object store repository, or a general storage repository supported by a file system.

In one embodiment, server 414 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

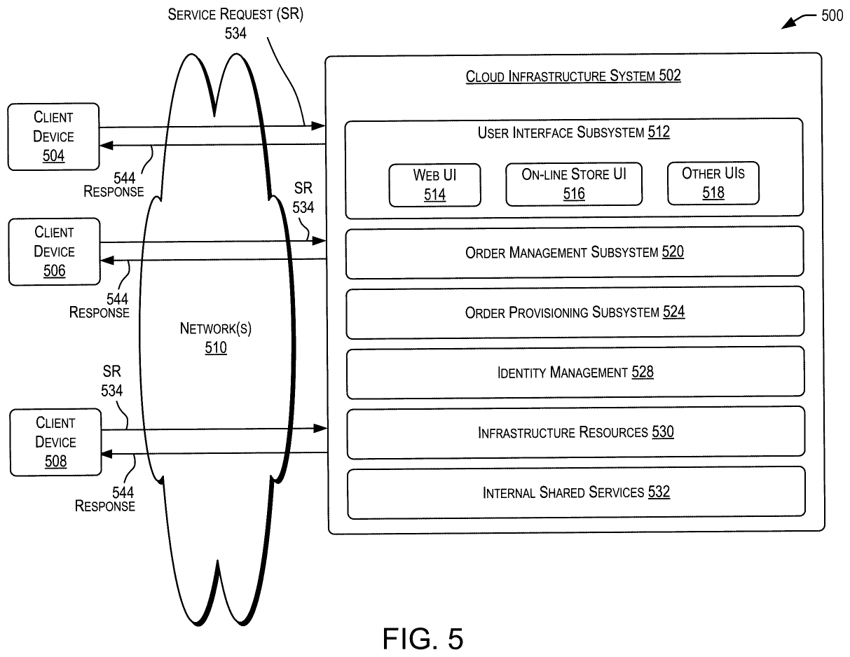

FIG. 5 is a simplified block diagram of a cloud-based system environment in which prioritizing analysis of anomalies in a network, in accordance with certain aspects. In the embodiment depicted in FIG. 5, cloud infrastructure system 502 may provide one or more cloud services that may be requested by users using one or more client computing devices 504, 506, and 508. Cloud infrastructure system 502 may comprise one or more computers and/or servers that may include those described above for server 414. The computers in cloud infrastructure system 502 may be organized as general purpose computers, specialized server computers, server farms, server clusters, or any other appropriate arrangement and/or combination.

Network(s) 510 may facilitate communication and exchange of data between clients 504, 506, and 508 and cloud infrastructure system 502. Network(s) 510 may include one or more networks. The networks may be of the same or different types. Network(s) 510 may support one or more communication protocols, including wired and/or wireless protocols, for facilitating the communications.

The embodiment depicted in FIG. 5 is only one example of a cloud infrastructure system and is not intended to be limiting. It should be appreciated that, in some other aspects, cloud infrastructure system 502 may have more or fewer components than those depicted in FIG. 5, may combine two or more components, or may have a different configuration or arrangement of components. For example, although FIG. 5 depicts three client computing devices, any number of client computing devices may be supported in alternative aspects.

The term cloud service is generally used to refer to a service that is made available to users on demand and via a communication network such as the Internet by systems (e.g., cloud infrastructure system 502) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 510 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 502 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 502 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 502. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 502. Cloud infrastructure system 502 then performs processing to provide the services requested in the tenant's subscription order. Cloud infrastructure system 502 may be configured to provide one or even multiple cloud services.

Cloud infrastructure system 502 may provide the cloud services via different deployment models. In a public cloud model, cloud infrastructure system 502 may be owned by a third party cloud services provider and the cloud services are offered to any general public tenant, where the tenant can be an individual or an enterprise. In certain other aspects, under a private cloud model, cloud infrastructure system 502 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 502 and the services provided may be shared by several organizations in a related community. Various other models such as hybrids of the above mentioned models may also be used.

Client computing devices 504, 506, and 508 may be of different types (such as devices 402, 404, 406, and 408 depicted in FIG. 4) and may be capable of operating one or more client applications. A user may use a client device to interact with cloud infrastructure system 502, such as to request a service provided by cloud infrastructure system 502.

In some aspects, the processing performed by cloud infrastructure system 502 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 502 for determining the intent of an utterance. The data used for this analysis may include structured data (e.g., data stored in a database or structured according to a structured model) and/or unstructured data (e.g., data blobs (binary large objects)).

As depicted in the embodiment in FIG. 5, cloud infrastructure system 502 may include infrastructure resources 530 that are utilized for facilitating the provision of various cloud services offered by cloud infrastructure system 502. Infrastructure resources 530 may include, for example, processing resources, storage or memory resources, networking resources, and the like.

In certain aspects, to facilitate efficient provisioning of these resources for supporting the various cloud services provided by cloud infrastructure system 502 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 502 may itself internally use services 532 that are shared by different components of cloud infrastructure system 502 and which facilitate the provisioning of services by cloud infrastructure system 502. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 502 may comprise multiple subsystems. These subsystems may be implemented in software, or hardware, or combinations thereof. As depicted in FIG. 5, the subsystems may include a user interface subsystem 512 that enables users of cloud infrastructure system 502 to interact with cloud infrastructure system 502. User interface subsystem 512 may include various different interfaces such as a web interface 514, an online store interface 516 where cloud services provided by cloud infrastructure system 502 are advertised and are purchasable by a consumer, and other interfaces 518. For example, a tenant may, using a client device, request (service request 534) one or more services provided by cloud infrastructure system 502 using one or more of interfaces 514, 516, and 518. For example, a tenant may access the online store, browse cloud services offered by cloud infrastructure system 502, and place a subscription order for one or more services offered by cloud infrastructure system 502 that the tenant wishes to subscribe to. The service request may include information identifying the tenant and one or more services that the tenant desires to subscribe to. For example, a tenant may place a subscription order for a chatbot related service offered by cloud infrastructure system 502. As part of the order, the client may provide information identifying the input (e.g. utterances).

In certain aspects, such as the embodiment depicted in FIG. 5, cloud infrastructure system 502 may comprise a service management subsystem (OMS) 520 that is configured to process the new order. As part of this processing, OMS 520 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 520 may then invoke the service provisioning subsystem (OPS) 524 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 524 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 502 may send a response or notification 544 to the requesting tenant to indicate when the requested service is now ready for use. In some instances, information (e.g., a link) may be sent to the tenant that enables the tenant to start using and availing the benefits of the requested services.

Cloud infrastructure system 502 may provide services to multiple tenants. For each tenant, cloud infrastructure system 502 is responsible for managing information related to one or more subscription orders received from the tenant, maintaining tenant data related to the orders, and providing the requested services to the tenant or clients of the tenant. Cloud infrastructure system 502 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 502 may provide services to multiple tenants in parallel. Cloud infrastructure system 502 may store information for these tenants, including possibly proprietary information. In certain aspects, cloud infrastructure system 502 comprises an identity management subsystem (IMS) 528 that is configured to manage tenant's information and provide the separation of the managed information such that information related to one tenant is not accessible by another tenant. IMS 528 may be configured to provide various security-related services such as identity services, such as information access management, authentication and authorization services, services for managing tenant identities and roles and related capabilities, and the like.

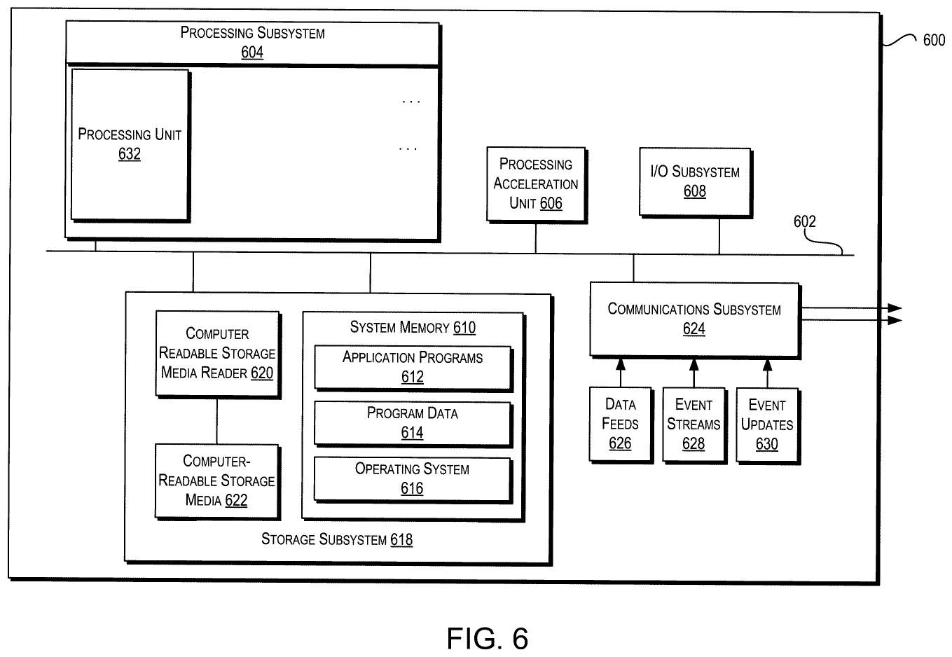

FIG. 6 illustrates an exemplary computer system 600 that may be used to implement certain aspects. As shown in FIG. 6, computer system 600 includes various subsystems including a processing subsystem 604 that communicates with a number of other subsystems via a bus subsystem 602. These other subsystems may include a processing acceleration unit 606, an I/O subsystem 608, a storage subsystem 618, and a communications subsystem 624. Storage subsystem 618 may include non-transitory computer-readable storage media including storage media 622 and a system memory 610.

Bus subsystem 602 provides a mechanism for letting the various components and subsystems of computer system 600 communicate with each other as intended. Although bus subsystem 602 is shown schematically as a single bus, alternative aspects of the bus subsystem may utilize multiple buses. Bus subsystem 602 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 604 controls the operation of computer system 600 and may comprise one or more processors, application specific integrated circuits (ASICs), or field programmable gate arrays (FPGAs). The processors may be single core or multicore processors. The processing resources of computer system 600 can be organized into one or more processing units 632, 634, etc. A processing unit may include one or more processors, one or more cores from the same or different processors, a combination of cores and processors, or other combinations of cores and processors. In some aspects, processing subsystem 604 can include one or more special purpose co-processors such as graphics processors, digital signal processors (DSPs), or the like. In some aspects, some or all of the processing units of processing subsystem 604 can be implemented using customized circuits, such as application specific integrated circuits (ASICs), or field programmable gate arrays (FPGAs).

In some aspects, the processing units in processing subsystem 604 can execute instructions stored in system memory 610 or on computer readable storage media 622. In various aspects, the processing units can execute a variety of programs or code instructions and can maintain multiple concurrently executing programs or processes. At any given time, some or all of the program code to be executed can be resident in system memory 610 and/or on computer-readable storage media 622 including potentially on one or more storage devices. Through suitable programming, processing subsystem 604 can provide various functionalities described above. In instances where computer system 600 is executing one or more virtual machines, one or more processing units may be allocated to each virtual machine.

In certain aspects, a processing acceleration unit 606 may optionally be provided for performing customized processing or for off-loading some of the processing performed by processing subsystem 604 so as to accelerate the overall processing performed by computer system 600.

I/O subsystem 608 may include devices and mechanisms for inputting information to computer system 600 and/or for outputting information from or via computer system 600. In general, use of the term input device is intended to include all possible types of devices and mechanisms for inputting information to computer system 600. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 600 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 618 provides a repository or data store for storing information and data that is used by computer system 600. Storage subsystem 618 provides a tangible non-transitory computer-readable storage medium for storing the basic programming and data constructs that provide the functionality of some aspects. Storage subsystem 618 may store software (e.g., programs, code modules, instructions) that when executed by processing subsystem 604 provides the functionality described above. The software may be executed by one or more processing units of processing subsystem 604. Storage subsystem 618 may also provide a repository for storing data used in accordance with the teachings of this disclosure.

Storage subsystem 618 may include one or more non-transitory memory devices, including volatile and non-volatile memory devices. As shown in FIG. 6, storage subsystem 618 includes a system memory 610 and a computer-readable storage media 622. System memory 610 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 600, such as during start-up, may typically be stored in the ROM. The RAM typically contains data and/or program modules that are presently being operated and executed by processing subsystem 604. In some implementations, system memory 610 may include multiple different types of memory, such as static random access memory (SRAM), dynamic random access memory (DRAM), and the like.

Byway of example, and not limitation, as depicted in FIG. 6, system memory 610 may load application programs 612 that are being executed, which may include various applications such as Web browsers, mid-tier applications, relational database management systems (RDBMS), etc., program data 614, and an operating system 616. By way of example, operating system 616 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 622 may store programming and data constructs that provide the functionality of some aspects. Computer-readable media 622 may provide storage of computer-readable instructions, data structures, program modules, and other data for computer system 600. Software (programs, code modules, instructions) that, when executed by processing subsystem 604 provides the functionality described above, may be stored in storage subsystem 618. By way of example, computer-readable storage media 622 may include non-volatile memory such as a hard disk drive, a magnetic disk drive, an optical disk drive such as a CD ROM, digital video disc (DVD), a Blu-Ray® disk, or other optical media. Computer-readable storage media 622 may include, but is not limited to, Zip® drives, flash memory cards, universal serial bus (USB) flash drives, secure digital (SD) cards, DVD disks, digital video tape, and the like. Computer-readable storage media 622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 618 may also include a computer-readable storage media reader 620 that can further be connected to computer-readable storage media 622. Reader 620 may receive and be configured to read data from a memory device such as a disk, a flash drive, etc.

In certain aspects, computer system 600 may support virtualization technologies, including but not limited to virtualization of processing and memory resources. For example, computer system 600 may provide support for executing one or more virtual machines. In certain aspects, computer system 600 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 600. Accordingly, multiple operating systems may potentially be run concurrently by computer system 600.

Communications subsystem 624 provides an interface to other computer systems and networks. Communications subsystem 624 serves as an interface for receiving data from and transmitting data to other systems from computer system 600. For example, communications subsystem 624 may enable computer system 600 to establish a communication channel to one or more client devices via the Internet for receiving and sending information from and to the client devices. For example, the communications subsystem may be used to transmit a response to a user regarding the inquiry for a chatbot.

Communications subsystem 624 may support both wired and/or wireless communication protocols. For example, in certain aspects, communications subsystem 624 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 624 can provide wired network connectivity (e.g., Ethernet) in addition to or instead of a wireless interface.

Communications subsystem 624 can receive and transmit data in various forms. For example, in some aspects, in addition to other forms, communications subsystem 624 may receive input communications in the form of structured and/or unstructured data feeds 626, event streams 628, event updates 630, and the like. For example, communications subsystem 624 may be configured to receive (or send) data feeds 626 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 624 may be configured to receive data in the form of continuous data streams, which may include event streams 628 of real-time events and/or event updates 630, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 624 may also be configured to communicate data from computer system 600 to other computer systems or networks. The data may be communicated in various different forms such as structured and/or unstructured data feeds 626, event streams 628, event updates 630, and the like to one or more databases that may be in communication with one or more streaming data source computers coupled to computer system 600.

Computer system 600 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 600 depicted in FIG. 6 is intended only as a specific example. Many other configurations having more or fewer components than the system depicted in FIG. 6 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
accessing a plurality of network traffic measurements along a plurality of dimensions, wherein the plurality of dimensions comprises at least a first dimension and a second dimension;
for the plurality of network traffic measurements, determining a plurality of aggregate values for the plurality of dimensions; wherein the plurality of aggregate values comprises:
a first aggregate value for the first dimension, and
a second aggregate value for the second dimension;
for each network traffic measurement of the plurality of network traffic measurements, determining a plurality of dimension-specific distances away from the plurality of aggregate values for the plurality of dimensions; wherein the plurality of dimension-specific distances comprises:
a first dimension-specific distance away from the first aggregate value for the first dimension, and
a second dimension-specific distance away from the second aggregate value for the second dimension;
determining a first subset of network traffic measurements with at least one dimension-specific distance of the plurality of dimension-specific distances above a threshold distance;
determining a second subset of network traffic measurements comprising, for each dimension, one or more network traffic measurements having dimension-specific distances within a threshold number of top dimension-specific distances for the dimension;
determining a third subset of network traffic measurements based at least in part on an intersection between the first subset and the second subset;
for each dimension of the plurality of dimensions, determining a dimension-specific value range for network traffic measurements of the third subset of network traffic measurements;
for each dimension of each network traffic measurement of the third subset, scaling a dimension-specific distance for the dimension based at least in part on the dimension-specific value range for the dimension;
combining the scaled dimension-specific distances for each network traffic measurement of the third subset to determine a set of aggregate scores;
determining and storing information identifying a fourth subset of network traffic measurements in a network traffic analysis dataset based at least in part on the set of aggregate scores.

2. The computer-implemented method of claim 1, wherein the first dimension-specific distance is measured in terms of standard deviations of the first dimension away from the first aggregate value and the second dimension-specific distance is measured in terms of standard deviations of the second dimension away from the second aggregate value.

3. The computer-implemented method of claim 1, wherein the scaling comprises linear scaling along the dimension-specific value range for the dimension.

4. The computer-implemented method of claim 1, further comprising triggering an electronic notification to a user associated with the network traffic analysis dataset.

5. The computer-implemented method of claim 1, further comprising causing display, in a client device of a user analyzing the plurality of network traffic measurements, of network traffic measurements of the network traffic analysis dataset in response to determining and storing the information identifying the fourth subset of network traffic measurements,
wherein the causing display of the network traffic measurements of the network traffic analysis dataset comprises causing display of the network traffic measurements in an order based on the set of aggregate scores.

6. The computer-implemented method of claim 1, further comprising storing a plurality of dimension-specific weights for the plurality of dimensions; wherein the scaling the dimension is further based at least in part on the dimension-specific weight for the dimension.

7. The computer-implemented method of claim 1, further comprising determining a dimension-specific weight of the first dimension based at least in part on feedback from a network traffic analysis pipeline, wherein the feedback indicates a frequency by which network traffic measurements having higher values for the first dimension than other network traffic measurements are labeled as anomalous.

8. The computer-implemented method of claim 1, wherein the first aggregate value is a mean of values for the first dimension and the second aggregate value is a mean of values for the second dimension.

9. The computer-implemented method of claim 1, wherein the plurality of measurements are sizes of messages or other network traffic items, request sizes, response sizes, payload sizes, packet sizes, frequencies or volumes of network traffic items of a certain type, frequencies or volumes of network traffic over a window of time, an amount of time over which network traffic items are transmitted, an amount of time between network traffic items, or any combination thereof.

10. The computer-implemented method of claim 1, wherein the plurality of dimensions comprise size categories of network traffic items, frequency categories of network traffic items of a particular type, a source node, address, application, gateway, or service of network traffic data, a destination node, address, application, gateway, or service of network traffic data, a user associated with network traffic items, a tool or browser used for processing network traffic items, a categorical time or window of time of network traffic items, a categorical time or window of time between network traffic items, or another particular characteristic of network traffic items.

11. A computer-program product comprising one or more non-transitory machine-readable storage media, including stored instructions configured to cause a computing system to perform a set of actions including:
accessing a plurality of network traffic measurements along a plurality of dimensions, wherein the plurality of dimensions comprises at least a first dimension and a second dimension;
for the plurality of network traffic measurements, determining a plurality of aggregate values for the plurality of dimensions; wherein the plurality of aggregate values comprises:
a first aggregate value for the first dimension, and
a second aggregate value for the second dimension;
for each network traffic measurement of the plurality of network traffic measurements, determining a plurality of dimension-specific distances away from the plurality of aggregate values for the plurality of dimensions; wherein the plurality of dimension-specific distances comprises:
a first dimension-specific distance away from the first aggregate value for the first dimension, and
a second dimension-specific distance away from the second aggregate value for the second dimension;
determining a first subset of network traffic measurements with at least one dimension-specific distance of the plurality of dimension-specific distances above a threshold distance;
determining a second subset of network traffic measurements comprising, for each dimension, one or more network traffic measurements having dimension-specific distances within a threshold number of top dimension-specific distances for the dimension;
determining a third subset of network traffic measurements based at least in part on an intersection between the first subset and the second subset;
for each dimension of the plurality of dimensions, determining a dimension-specific value range for network traffic measurements of the third subset of network traffic measurements;
for each dimension of each network traffic measurement of the third subset, scaling a dimension-specific distance for the dimension based at least in part on the dimension-specific value range for the dimension;
combining the scaled dimension-specific distances for each network traffic measurement of the third subset to determine a set of aggregate scores;
determining and storing information identifying a fourth subset of network traffic measurements in a network traffic analysis dataset based at least in part on the set of aggregate scores.

12. The computer-program product of claim 11, wherein the first dimension-specific distance is measured in terms of standard deviations of the first dimension away from the first aggregate value and the second dimension-specific distance is measured in terms of standard deviations of the second dimension away from the second aggregate value.

13. The computer-program product of claim 11, wherein the scaling comprises linear scaling along the dimension-specific value range for the dimension.

14. The computer-program product of claim 11, wherein the set of actions further include:
triggering an electronic notification to a user associated with the network traffic analysis dataset.

15. The computer-program product of claim 11, wherein the set of actions further include:
causing display, in a client device of a user analyzing the plurality of network traffic measurements, of network traffic measurements of the network traffic analysis dataset in response to determining and storing the information identifying the fourth subset of network traffic measurements,
wherein the causing display of the network traffic measurements of the network traffic analysis dataset comprises causing display of the network traffic measurements in an order based on the set of aggregate scores.

16. A system comprising:
one or more processors;
one or more non-transitory computer-readable media storing instructions, which, when executed by the system, cause the system to perform a set of actions including:
accessing a plurality of network traffic measurements along a plurality of dimensions, wherein the plurality of dimensions comprises at least a first dimension and a second dimension;
for the plurality of network traffic measurements, determining a plurality of aggregate values for the plurality of dimensions; wherein the plurality of aggregate values comprises:
a first aggregate value for the first dimension, and
a second aggregate value for the second dimension;
for each network traffic measurement of the plurality of network traffic measurements, determining a plurality of dimension-specific distances away from the plurality of aggregate values for the plurality of dimensions; wherein the plurality of dimension-specific distances comprises:
a first dimension-specific distance away from the first aggregate value for the first dimension, and
a second dimension-specific distance away from the second aggregate value for the second dimension;
determining a first subset of network traffic measurements with at least one dimension-specific distance of the plurality of dimension-specific distances above a threshold distance;
determining a second subset of network traffic measurements comprising, for each dimension, one or more network traffic measurements having dimension-specific distances within a threshold number of top dimension-specific distances for the dimension;
determining a third subset of network traffic measurements based at least in part on an intersection between the first subset and the second subset;
for each dimension of the plurality of dimensions, determining a dimension-specific value range for network traffic measurements of the third subset of network traffic measurements;
for each dimension of each network traffic measurement of the third subset, scaling a dimension-specific distance for the dimension based at least in part on the dimension-specific value range for the dimension;
combining the scaled dimension-specific distances for each network traffic measurement of the third subset to determine a set of aggregate scores;
determining and storing information identifying a fourth subset of network traffic measurements in a network traffic analysis dataset based at least in part on the set of aggregate scores.

17. The system of claim 16, wherein the set of actions further includes:
storing a plurality of dimension-specific weights for the plurality of dimensions; wherein the scaling the dimension is further based at least in part on the dimension-specific weight for the dimension.

18. The system of claim 16, wherein the set of actions further includes:
determining a dimension-specific weight of the first dimension based at least in part on feedback from a network traffic analysis pipeline, wherein the feedback indicates a frequency by which network traffic measurements having higher values for the first dimension than other network traffic measurements are labeled as anomalous.

19. The system of claim 16, wherein the first aggregate value is a mean of values for the first dimension and the second aggregate value is a mean of values for the second dimension.

20. The system of claim 16, wherein the plurality of measurements are sizes of messages or other network traffic items, request sizes, response sizes, payload sizes, packet sizes, frequencies or volumes of network traffic items of a certain type, frequencies or volumes of network traffic over a window of time, an amount of time over which network traffic items are transmitted, an amount of time between network traffic items, or any combination thereof.
